(19) United States
(12) Patent Application Publication
(10) Pub. No.: US 2022/0198355 A1
(43) Pub. Date: Jun. 23, 2022

(54) OPTIMIZED DELIVERY SCHEME

(71) Applicant: Manna Man Who Ltd., Petach Tikva (IL)

(72) Inventor: Aviv Ben Menachem, Petach Tikva (IL)

(21) Appl. No.: 17/456,761

(22) Filed: Nov. 29, 2021

Related U.S. Application Data
(60) Provisional application No. 63/129,136, filed on Dec. 22, 2020.

(51) Int. Cl. G06Q 10/06; G06Q 10/08; G06Q 50/12; G06Q 30/02; G01C 21/34

(52) U.S. Cl. CPC G06Q 10/06315; G06Q 10/08355; G06Q 50/12; G06Q 30/0202; G01C 21/3407; G06Q 10/0836; G06Q 30/0284; G06Q 10/06313; G06Q 30/0223

(57) ABSTRACT

A method, a system and a computer program product for providing efficient food delivery services. The method comprises determining based on a predicted demand within the delivery area, a food plan comprising predefined meals and generic meals associated with a plurality of concrete meals to be prepared and a delivery scheme for delivering food by delivery vehicles in accordance with the food delivery plan. After the determined quantity of the predefined meals is available for delivery, clients in the delivery area are enabled to order from the predefined meals. In response to a client making an order from the list, a respective meal is selected for delivery and the delivery scheme is automatically updated to enable fulfillment of the order.

### CROSS-REFERENCE TO RELATED APPLICATION

This application claims the benefit of provisional patent application No. 63/129,136 filed Dec. 22, 2020, titled “DELIVERY SCHEME”, which is hereby incorporated by reference in its entirety without giving rise to disavowment.

### TECHNICAL FIELD

The present disclosure relates to delivery services in general, and to optimization of food delivery, in particular.

### BACKGROUND

One major discipline of delivery services which is associated with many challenges is food delivery. Retail food delivery is a courier service in which a restaurant, a store, or an independent food-delivery company delivers food to a customer. An order is typically made either through a restaurant or grocer's website or mobile application, or through a food ordering company. The delivered items may include entrees, sides, drinks, desserts, or grocery items and are typically delivered in boxes or bags. The delivery person may normally drive a car, ride bikes or motorized scooters, or the like, for delivering the boxes and the bags to the customer. Autonomous vehicles, drones, robots or the like are being used to complete deliveries.

As delivery services and specifically food deliver is becoming increasingly popular, the number of delivery systems has increased, so have the logistical challenges related thereto, such as to tracking online orders, ensuring payments, preserving quality of the delivered products, and the like.

### BRIEF SUMMARY

One exemplary embodiment of the disclosed subject matter is a method comprising: determining a food delivery plan for a delivery area, wherein the food delivery plan comprises one or more types of predefined meals to be prepared, a quantity of each type and a delivery scheme, wherein the delivery scheme comprises a route for one or more vehicles carrying food in accordance with the food delivery plan, wherein the route is at least partially within the delivery area, wherein said determining the food delivery plan is performed based on a predicted demand within the delivery area; instructing one or more kitchens to prepare a plurality of meals in accordance with the food delivery plan, whereby the determined quantity of each predefined meals type is available for delivery; enabling clients in the delivery area to order meals from a list comprising the one or more types of predefined meals, wherein orders are made after the plurality of meals are prepared in accordance with the food delivery plan; in response to a client making an order from the list, automatically updating the route to include a leg that is associated with fulfilling the order; and instructing the one or more vehicles to drive in accordance with the route, whereby enabling fulfillment of the order.

Optionally, the one or more vehicles is instructed to commence driving in accordance with the route before the client performs the order, wherein after the one or more vehicles commenced driving in accordance with the route, the route is updated to include the leg, whereby modifying the delivery scheme of the vehicle in real-time and without requiring the one or more vehicles to reload a new meal to fulfill the order.

Optionally the method further comprises: subsequent to an elapsed time from preparation of the plurality of meals of a single type of meal reaching a freshness time threshold relating to the single type of meal, modifying an offer for sale of unsold meals from the plurality of meals of the single type of meal, whereby incentivizing consumption of the unsold meals of the single type.

Optionally the method further comprises: subsequent to the elapsed time from preparation of the plurality of meals of the single type of meal reaching a second freshness time threshold, performing a second modification of the offer for sale of the unsold meals of the single type.

Optionally, the predicted demand is determined based on historical food delivery data in the delivery area, wherein the historical food delivery data comprises at least one of: analysis of past orders, historic usage statistics of food ordering applications, and historic user reviews of users located in the delivery area.

Optionally, the list from which the clients can order meals is limited by current availability of meals carried by the one or more vehicles, whereby when an inventory of first type of meal is depleted from the one or more vehicles' storage, the first type of meal is no longer offered for sale for the clients located within the delivery area.

Optionally, the order of the client indicates a meeting point in which the order is to be fulfilled, wherein the client is not located at the meeting point when making the order. Optionally the method further comprises: providing a notification to the client a predetermined time before the one or more vehicles arrive to the meeting point, wherein the notification indicates a predicted arrival time of the one or more vehicles to the meeting point, whereby the client is enabled to timely reach the meeting point.

Optionally, the predetermined time is determined based on an estimated time required for the client to arrive to the meeting point, wherein the estimated time is determined based on historical behavior of the client, whereby a timing of the notification is personalized for the client.

Optionally, said enabling clients to order meals comprises: determining a price of a type of meal that is in stock within the one or more vehicles, wherein said determining is performed in a manner configured to reduce a price of the type of meal when a distance between a location of the client and the meeting point is increased.

Optionally the method further comprises: calculating a reverse tip to be bestowed on the client, wherein the reverse tip is determined based on a distance between a location of the client and the meeting point, whereby rewarding the client for arriving to a distant meeting point.

Another exemplary embodiment of the disclosed subject matter is a method comprising: offering to a client a menu of meals, wherein the menu comprises a generic meal, wherein the generic meal is associated with a set of alternative concrete meals, wherein each concrete meal of the set of alternative concrete meals fulfils an order of the generic meal, wherein a predetermined amount of concrete meals of the set of alternative concrete meals is pre-mounted on a delivery vehicle, wherein the pre-mounted concrete meals are prepared and packed in advanced prior to a client making an order of the generic meal; receiving an order by the client of the generic meal; in response to said receiving the order of the generic meal, selecting a concrete meal from the set of alternative concrete meals, wherein said selecting is based on an inventory of the delivery vehicle; and instructing the delivery vehicle to fulfill the order by delivering to the client the selected concrete meal.

Optionally, said selecting is further based on predicted demand by other clients for the set of alternative concrete meals.

Optionally, the menu indicates a first price for the generic meal, wherein the menu further comprises the concrete meal and indicates a second price for the concrete meal, wherein the first price is lower than the second price, whereby a same meal is priced differently based on a specification constraint in the order made by the client.

Optionally the method further comprises: wherein offering a second menu of meals to a second client, wherein the second menu comprises a second generic meal, wherein the second generic meal is associated with a subset of the set of alternative concrete meals, wherein each concrete meal of the subset of the set of alternative concrete meals fulfils an order of the second generic meal, wherein orders made by the second client are fulfilled using inventory of the delivery vehicle. The second client is different than the client in at least one of: a client's location, a selected delivery method, client's demographic properties, and client's history of orders, and the second menu is different than the menu in a specification level of one or more meals offered.

Optionally the method further comprises: wherein dynamically updating the menu, wherein said updating comprises updating at least one of: a composition of the menu, a specification level of the generic meal, and a price of the generic meal. Optionally, said dynamically updating is performed based on at least one of: a current availability of meals in the inventory of the delivery vehicle, food freshness constraints, and an estimated time of arrival to the client.

Optionally, said offering comprises displaying a dynamic version of the menu to the client in each time frame of a set of timeframes, wherein the set of timeframes comprise two timeframes that are comprised by a time window during which the delivery vehicle retains the inventory and does not replenish the inventory.

Optionally, the dynamic version comprises a timer indicating a time in which the order must be made in order for a current displayed price to be in effect, whereby incentivizing the client to perform the order prior to the delivery vehicle reaching a location of the client, whereby incentivizing optimal route for the delivery vehicle.

Optionally, each meal in the menu of meals is associated with a meal specification level indicating a limitation on client requirements on an ordered meal, wherein the meal comprises a predefined limited amount of client requirements in accordance with the meal specification level, wherein each alternative concrete meal is associated with a combination of alternatives to the client requirements in accordance with the limitation of the meal specification level.

Optionally, the meal specification level is selected from a group consisting of: a high specification level, a first medium specific level, a second medium level, and a low specification level; wherein in the high specification level the client is enabled to select a dish type and a delivery location; wherein in the first medium specification level the client is enabled to select the dish type but not the delivery location; wherein in the second medium specification level the client is enabled to select the delivery location but not the dish type; wherein in the low specification level the client is unable to select the delivery location and the dish type.

Optionally, in response to the meal specification level of an order meal being the first medium specification level or the low specification level, automatically determining the delivery location based on a current location of the delivery vehicle, and providing a notification to the client of the determined delivery location.

Yet another exemplary embodiment of the disclosed subject matter is a food delivery system adapted to perform the steps of: offering to a client a menu of meals, wherein the menu comprises a generic meal, wherein the generic meal is associated with a set of alternative concrete meals, wherein each concrete meal of the set of alternative concrete meals fulfils an order of the generic meal, wherein a predetermined amount of concrete meals of the set of alternative concrete meals is pre-mounted on a delivery vehicle, wherein the pre-mounted concrete meals are prepared and packed in advanced prior to a client making an order of the generic meal; receiving an order by the client of the generic meal; in response to said receiving the order of the generic meal, selecting a concrete meal from the set of alternative concrete meals, wherein said selecting is based on an inventory of the delivery vehicle; and instructing the delivery vehicle to fulfill the order by delivering to the client the selected concrete meal.

Yet another exemplary embodiment of the disclosed subject matter is a computer program product comprising a non-transitory computer readable storage medium retaining program instructions, which program instructions when read by a processor, cause the processor to perform a method comprising: determining a food delivery plan for a delivery area, wherein the food delivery plan comprises one or more types of predefined meals to be prepared, a quantity of each type and a delivery scheme, wherein the delivery scheme comprises a route for one or more vehicles carrying food in accordance with the food delivery plan, wherein the route is at least partially within the delivery area, wherein said determining the food delivery plan is performed based on a predicted demand within the delivery area; instructing one or more kitchens to prepare a plurality of meals in accordance with the food delivery plan, whereby the determined quantity of each predefined meals type is available for delivery; enabling clients in the delivery area to order meals from a list comprising the one or more types of predefined meals, wherein orders are made after the plurality of meals are prepared in accordance with the food delivery plan; in response to a client making an order from the list, automatically updating the route to include a leg that is associated with fulfilling the order; and instructing the one or more vehicles to drive in accordance with the route, whereby enabling fulfillment of the order.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1C show flowchart diagrams of a method, in accordance with some exemplary embodiments of the disclosed subject matter;

FIG. 2 shows a flowchart diagram of a method, in accordance with some exemplary embodiments of the disclosed subject matter;

FIG. 3 shows a schematic illustration of an exemplary architecture, in accordance with some exemplary embodiments of the disclosed subject matter;

FIG. 4 shows a block diagram of an apparatus, in accordance with some exemplary embodiments of the disclosed subject matter; and

FIGS. 5A-B show schematic illustration of an exemplary delivery container, in accordance with some exemplary embodiments of the disclosed subject matter.

### DETAILED DESCRIPTION

One technical problem dealt with by the disclosed subject matter is enhancing an efficiency of delivery service and particularly food deliveries. In some exemplary embodiments, food deliveries may be ordered remotely, e.g., via a website, a phone call, using a computing device application, or the like. Food deliveries may be typically expected to provide the ordered type of food to a selected address of a client, e.g., her home address, her office address, or the like. Additionally or alternatively, other aspects of food delivery may include catering and wholesale food service deliveries to restaurants, cafeterias, health care facilities, caterers by foodservice distributors, or the like.

In some exemplary embodiments, food establishments or corporations such as restaurants, catering companies, or the like, may offer food delivery services using their own crew of delivery personnel. Typically, a delivery may be initialized by an end user, using a client, or the like. As an example, an end-user generates a dish order, which is provided and processed at a selected food corporation, which next fulfills the order by preparing the dish and delivering the dish to the end-user. This way, the food establishment may dependent on a type, a time, and quantity of individual orders initiated by individual clients, on a latency of preparing the meal and preparing the delivery after processing the orders, or the like. Such inhouse delivery service may multiple drawbacks such as having a large latency that reduces the food freshness, having low efficiency delivery routes that do not take into account of future deliveries to same areas, making wasteful food that is not ordered, having confusions between ordered deliveries that may cause incorrect delivery, or the like. Additionally or alternatively, such scheme of ordering and preparing dishes may lack efficiency, as it may require each meal to be prepared separately and delivered separately. The inefficiency of such scheme may be also manifested into an inefficient usage of gasoline, or other energy source utilized by the delivery vehicle in performing the inefficient delivery scheme, inefficient time planning, inefficient food material consumption, or the like. It may be desired to overcome these drawbacks and remove the dependency on the type, time, and quantity of the individual orders, while increasing efficiency and reducing the overall energy consumption in delivering the orders.

Another technical problem dealt with by the disclosed subject matter is improving combined delivery schemes. In some exemplary embodiments, deliveries to similar locations may be combined for efficiency purposes. Such combination, especially when using inefficient delivery scheme, may be limited, and cannot be planned ahead of time. As an example, in case two orders are placed at a similar time at a same restaurant, or in close proximity, such as about 5 minutes apart, about 500 meters apart, or the like, and the planned delivery route enables to provide both deliveries to the target destinations, then the delivery man may combine the orders in the same delivery route. However, such a scenario is not planned ahead, thus most matching orders and locations will not be efficiently handled when using the inefficient delivery scheme.

Yet another technical problem dealt with by the disclosed subject matter is enabling low-budget meal packages such as single meal deliveries to be provided in an efficient manner. In some cases, efficiency may be translated into profitability, as costs may be reduced in view of the efficient delivery manner. In some exemplary embodiments, most restaurants have minimum order rates, that prevent customers from ordering one dish for a delivery, as this may not be profitable when considering the cost of the delivery (the gas cost, the time of the delivery man, or the like). It may be desired to enable customers to purchase one item only, without compromising on a profitability of the delivery.

Yet another technical problem dealt with by the disclosed subject matter is enhancing a delivery speed. In some exemplary embodiments, deliveries are timely and inefficient as the delivery men are required to provide ordered meal packages to a door of the client, which may be difficult to locate, difficult to access, requires the client's coordination, or the like. In some exemplary embodiments, it may be inefficient to require the delivery vehicle to deliver each order to a door of each target address such as each office or apartment building. In some exemplary embodiments, a door delivery may consume many minutes for each address, and the driver would lose precious limited delivery time of the remaining items he is carrying. It may be desired to provide an optimization of a point-to-point delivery method, such as by providing the deliveries to advantageous locations for both receiving and providing parties.

Yet another technical problem dealt with by the disclosed subject matter is authenticating orders and enabling to match orders to clients. In some scenarios, a person may impersonate a client and obtain his delivery fraudulently. In some scenarios, a client may be verified as the authentic client, but may receive a wrong delivery due to a mistake of the packing party, a mistake of the delivery man, or the like. In some exemplary embodiments, it may be desired to ensure that every client receiving a delivery is in fact the paying client, and that the delivery is what the client ordered.

One technical solution provided by the disclosed subject matter is preparing in advance, a plurality of predefined meals to be delivered, in order optimizes delivery efficiency and speed. In some exemplary embodiments, a food delivery plan may be determined for each deliver area. The food delivery plan may comprise types of dishes to be made at each time of day, a quantity of each type, an optimized delivery route, a delivery scheme for delivering the plurality of meals, or the like. In some exemplary embodiments, the food delivery plan and a delivery scheme for performing delivery thereof may be determined based on predicted locations, times, predicted food type preferences, or the like. The food delivery plan may be determined based on local or global crowd-based behavior, such as the fact that people usually eat lunch and dinner during similar times of the day, what types are eaten in each time of the day, or the like. In some cases, the food delivery scheme may be preferably implemented in a populous area, in which clients may be in close proximity to each other. As an example, a large number, such as about 400, 500 or the like of identical meals of hamburger and fries may be prepared for a lunch timeframe. The identical meals may be basic meals or general meals that may usually be ordered by clients for lunch, such as a Big Mac® Combo meal of McDonald's®, or the like.

In some exemplary embodiments, the food delivery plan may be determined prior to receiving any order from clients. Instead of waiting for clients to order, an overall demand for a certain dish by a population of users in a certain area may be predicted, defined, or the like, such as based on crowd behavior identified in the delivery area. In some exemplary embodiments, based on the predicted demand, a plurality of kitchens configured for takeaway delivery, such as restaurants, designated kitchens, or the like, may be instructed to prepare a plurality of meals in accordance with the food delivery plan. Each kitchen may prepare and package a certain type, some of the types, or the like, in accordance with the capacity, availability, designation, or the like, so that the predetermined amount of meals be available at each timeframe. In some exemplary embodiments, an algorithm of the food delivery scheme may be configured to determine an advantageous number of deliveries to be mounted for each delivery route, or for each kitchen or packing center, for each delivery area the route is targeting, or the like. The number of each item type may be determined based on a predicted demand for the item type in advance and before all the end-users have placed their respective orders. In some exemplary embodiments, each type of meals may be mounted in a designated compartment within a delivery container of the delivery vehicle, to enable the delivery staff to easily collect the meal and deliver it to the client.

In some exemplary embodiments, the prepared meals may be packed, inserted to a food delivery medium such as a bag, or the like, and mounted to a delivery vehicle. In some exemplary embodiments, since the meals are all identical, there may be no need to pack each meal in a designated package including identifying information of ordering customers, such as a name of a customer. In some exemplary embodiments, the prepared and packed meals may be presented to clients for order via delivery platforms such as a mobile application, a website, private messaging mediums, or the like. The clients may be enabled to make orders of the predefined meal in any selected quantity of meals. In some exemplary embodiments, the meal packages may be mounted to the delivery vehicle regardless of the processed deliveries. As an example, assuming only 20 meal orders were processed, a larger number of 50 meals may be mounted to the delivery vehicle. The remaining 30 meals may be offered for clients in the delivery area for order, thereby decreasing the time for preparing and delivering thereof.

In some exemplary embodiments, the food delivery scheme may utilize one or more Artificial Intelligence (AI) system, route optimization algorithms, resource allocation algorithms, predictors, classifiers, Artificial Neural Networks (ANNs), a combination thereof, or the like. In some exemplary embodiments, the food delivery scheme may be configured to optimize the delivery route to provide the quickest or shortest route while ensuring the delivered meals are still fresh, e.g., have a delivery time that is below a freshness threshold. In some exemplary embodiments, the food delivery scheme may be configured to project an optimized route for each delivery, an optimized amount of delivered packages for each delivery, or the like. In some exemplary embodiments, the route may be modified in real time, such as based on new orders that are processed, e.g., based on a proximity of ordering addresses to the delivery man's current location, proximity of an ordering address to the remaining ordering addresses in the area, a freshness level of the food, or the like.

In some exemplary embodiments, the food delivery scheme may be configured to determine a delivery route that complies with a maximum delivery time threshold. In some exemplary embodiments, the maximum delivery time threshold may indicate a time limit from food preparation to completing the delivery, from food packaging to completing the delivery, or the like. For example, in case the meals include hamburger meals, a delivery time threshold may be determined, e.g., 45 minutes, from preparation to delivery, indicating that for each delivery round, the last delivered hamburger meal is required to be provided no more than 45 minutes after preparation. In some exemplary embodiments, meals left unsold after a period of the maximum delivery time threshold, may be disposed, sold at a discount, provided as a donation, a charity, or the like. In some exemplary embodiments, different delivery time thresholds may be determined for different types of dishes, for different clients, or the like. In some exemplary embodiments, different delivery time thresholds may be determined for different phases of the food. For example, a freshness threshold may indicate that the food is fresh until the threshold but is still edible thereafter, while a mildew threshold may indicate that the food is not to be consumed, that the food does not comply with food regulations, or the like.

In some exemplary embodiments, a predetermined amount of meals to be prepared at each time frame, such as an hour, a day, a week, or the like, may be determined. The food delivery scheme may be configured to project a number of meals that are to be prepared of each type per delivery time in the day, number of items per dish or meal, or the like, e.g., utilizing an AI system or any other calculation. For example, an AI system may predict the demand for a certain item. For example, using an AI system it may be determined that 100 meals of pancakes are to be prepared for an area during a delivery time window of 12:15-1:00 PM, while 200 meals of pancakes are to be prepared for the same area during a delivery time window of 1:10-2:00 PM.

In some exemplary embodiments, the food delivery scheme may be configured to provide suggestions, recommendations, or the like, of meals such as via a notification, an alert, an advertisement, or the like. In some exemplary embodiments, clients may be provided with a meal suggestion in case a currently available meal matches a food preference of a user profile of the client, in case the client's address matches the delivery route, or the like. In some exemplary embodiments, the food delivery scheme may determine whether or not to suggest a meal to a client based on data-driven calculations, heuristics, predictions, or the like.

In some exemplary embodiments, the food delivery scheme may be configured to select from a list of possible dishes a dish to be offered on a menu, based on a prediction of dish demand. In some exemplary embodiments, the dish selection may be performed on a daily basis, a weekly basis, an hourly basis, a combination thereof, or the like. For example, every week new data may be gathered and used to define a weekly schedule including different dishes for each hour of the day. In some exemplary embodiments, upon selecting the menu, a digital menu that is accessible to clients may be modified respectively, e.g., via a corresponding mobile application, website, or any other communication medium. For example, during a first day, the AI system may predict that only hamburgers are to be included in the menu, while during a second day, the AI system may predict that cheesecakes are to be offered in the morning and pasta is to be offered in the evening. In some exemplary embodiments, the food delivery scheme may utilize data such as various criteria, heuristics, clients' past likings (e.g., based on client feedback), or the like, for determining the menu. In some exemplary embodiments, the food delivery scheme may be configured to determine prices for dishes that are predicted to generate the most output.

In some exemplary embodiments, the food delivery scheme may utilize a large historic database, accumulate various data parameters and values for the database, generate the database, or the like, in order to provide a result, a prediction, a recommendation, or the like. In some exemplary embodiments, the database may include delivery related information such as previous orders, application or website usage statistics, location information such as order addresses, proximity of ordering addresses to the kitchen's location, proximity of different ordering addresses in the area, dish variety, constrains of the remaining dishes such as aging constraints, or the like. In some exemplary embodiments, the database may include information associated to types of dishes such as a rating popularity of a dish on an ordering application of platform, global or local data trends of dish preferences that may be available publicly such as based on a number of google searches for a dish in a certain radius, city, country, or the like, a cost of a preparing the dish, different pricings that were used when selling the dish in the past, dish preparation timing constraints, dish quality expiration period (time from preparation of the dish until the dish is not acceptable for a quality delivery), dish ingredient constraints such as seasonal ingredients, dish popularity in context to season or time of year (e.g., soups in winter, salads in summer), an amount of time during which an ordered dish was on the menu, a similarity of dishes, comparative pricing of the dish (the pricing of a dish compared to pricings of other venues offering a same or similar dish), or the like. In some exemplary embodiments, based on the database or portions thereof, the food delivery scheme may provide an optimized route for delivery in real time, may determine or select dishes for the menu, may select dish quantities, or the like.

Another technical solution provided by the disclosed subject matter is limiting a meal specification level. In some exemplary embodiments, in order to broaden an efficiency of the food delivery scheme, the system may offer a meal with a defined limited amount of specifications or user requirements in order to further reduce associated resources with preparing and delivering the food item, and as a result reducing a cost of food preparation, delivery time and delivery cost. In some exemplary embodiments, as user requirements may be regarded by the system as constrains, the less requirements, the more efficient the system may be handled. In some exemplary embodiments, meals may be proposed to clients with one or more levels of details of specifications. In some exemplary embodiments, user may be encouraged to order less-specified dishes, e.g., by reducing a price of less-specified dishes, proposing bonus points or future discounts for ordering less-specified dishes, providing additional perks for ordering less-specified dishes, or the like. As an example, the user may select a specified item: a hamburger or a hotdog, or alternatively, select a less specified item, a meat dish that may be translated into either a hamburger or a hotdog. The less specified item may combine a set of alternative items, each of which may be considered as fulfilling the ordered item.

In some exemplary embodiments, a delivery route configured to provide food packages to a list of clients, may enable the clients to utilize at least one level of specification when performing an order. In some exemplary embodiments, a number of specification levels may be enabled simultaneously during a same route, or alternatively, one level may be enabled for clients of a delivery route, e.g., depending on the system's decision, on a recommendation of the food delivery scheme, or the like.

In some exemplary embodiments, a highest level of specification, which may be the least efficient for the food delivery scheme, may include selecting both a dish type and a delivery location. In some exemplary embodiments, a next, medium level of specification may include selecting a food choice without selecting a delivery location, or selecting a delivery location without selecting a food choice. The lowest level of specification may be avoiding from selecting a delivery location and food choice. It is noted that if no delivery location is selected, the user may need to approach the delivery location selected by the disclosed subject matter, such as a location in the delivery area, in which the food item may be provided to the user.

In some exemplary embodiments, a meal item with a lowest level of specification may include no preferences at all, referred to as a “Joker” meal. In such a case, the client may enable the system to select a meal for the client, such as based on the system's preference. For example, a client that has no preference for a specific meal, may order a “Joker” meal including any type of food, or any dish of a set of foods, e.g., main courses, meat dishes, vegetarian meals, or the like. In some exemplary embodiments, the system may utilize the “Joker” meals to balance over-estimated quantities of certain dishes, instead of throwing out the remaining excess dishes. The fulfillment of the “Joker” meals may be decided at the time of the delivery itself and not a-priori, based on the accumulated orders thus far, and the remaining inventory. For example, consider a delivery vehicle carrying 20 hamburgers and 20 hot dogs. If 10 orders of hamburger are obtained, followed by a “meat meal” joker item. On its face, it may appear that the meat meal joker item should be fulfilled by providing a hot dog item. However, if before reaching the customer, there are 18 more orders of hot dogs, the remaining inventory is of 2 hot dogs and 10 hamburgers at the time of delivery. The concretization of the meat meal may be performed at the delivery time, determining that it is better to provide a hamburger, so as to ensure sufficient inventory of hot dogs for future orders.

In some exemplary embodiments, enabling different levels of specification or detail, e.g., four different order configurations, may considerably reduce the estimated food waste, thereby enhancing the system's profit and efficiency. In some exemplary embodiments, in order to encourage clients to order a lower specification level meal, benefits and perks may be suggested to clients based on a level of specification.

In some exemplary embodiments, the menu may be dynamic and be updated based on current inventory, location of the delivery vehicle, food freshness, or the like. For example, based on remaining inventory, different joker items may be suggested to the clients. As another example, the cost of a high-inventory item or item that is about to become spoiled may be reduced to encourage its consumption. The presented menu may be different for different users, in view of their location and associated delivery vehicle. In some cases, the prices may be updated dynamically based on the location of the user and estimated time of arrival of the vehicle thereto, so as to increase efficiency. The menu may be displayed to the user with a timer indicating a time in which the order must be made in order for the displayed prices to be in effect. Such a timer may be utilized to incentivize the user to finish his order before the delivery vehicle reaches his street, so as to allow the delivery vehicle to fulfill the order when it arrives to the street and without backtracking its route.

Yet another technical solution provided by the disclosed subject matter is limiting a delivery process, to thereby limit the delivery time. In some exemplary embodiments, it may be desired to optimization a point-to-point delivery method. In some exemplary embodiments, it may be inefficient to require the delivery vehicle to deliver each order to a door of each target address such as each office or apartment building. In some exemplary embodiments, a door delivery may consume many minutes for each address, and the driver would lose precious limited delivery time of the remaining items he is carrying. In some exemplary embodiments, instead of delivering each order to the client's door, a designated application may be used to alert, such as by sending a push notification, sending an email, a text message, or the like, to each user to meet the delivery man, to take a delivery laid on the floor or elsewhere, or the like, at an entrance of the client's house, office, residence building, or the like, at a public road or street that is nearest to the user's address, or the like. In some exemplary embodiments, a notification may be provided seconds or minutes before the delivery arrives, indicating that the delivery is near and possibly indicating a meeting point or location, a predicted meeting time, a predicted delivery time, or the like. In some exemplary embodiments, the notification may include an estimated time to walk from the user's address to the meeting point where the delivery arrives, so that the user may make it on time.

In some exemplary embodiments, in order to encourage people to change their habits and accept the offer to go to the meeting point, instead of receiving the delivery right to the front door, one or more encouraging methods may be used. In some exemplary embodiments, an encouraging method may include providing an opposite tip (also referred to as a reverse tip), or bonus points, to users that agree to meet the delivery man. In some exemplary embodiments, the opposite tip may include a tip that is provided to the client by the food supplier, in contrary to typical tips that are provided from the client to the delivery man. In some exemplary embodiments, the opposite tips may be provided in case the client comes to the meeting point at time, comes to the meeting point at all, or the like. In some exemplary embodiments, the more the user is on time, the larger the opposite tip may be. In some exemplary embodiments, the opposite tip may include cash, digital currency, a discount on the delivery, a future bonus, a future discount, a future benefit, funny money, digital score or rating, or the like. For example, each minute that the delivery man waits for the client at the meeting point may reduce the tip. As another example, the tip may include a discount on the next purchase via an application or website of the food supplier. In some exemplary embodiments, based on past experience with the same user, or cohorts of similar users, the timing of sending the alert may be personalized, so as to reduce the amount of waiting time for both parties—the delivery vehicle and the customer. For example, some customers may quickly reach the entrance of their building, while others may take their time before putting on their shoes and going down the stairs to reach their entrance. As a result, the first type of customers may receive a notification closer to the time of arrival than the second type of customers.

Yet another technical solution provided by the disclosed subject matter is authenticating clients and matching orders to the clients. In some exemplary embodiments, since all delivered packages may be identical, the delivery man will not need to designate a specific delivery for each user, but merely select a selected quantity of packages, e.g., potentially of a target type. In some exemplary embodiments, the only user-specific designation may include identifying a quantity of meals ordered by the user, in case all the packages are identical. In some exemplary embodiments, a quantity of packages of each order may be indicated to the delivery man via a designated mobile application, website, communication medium, or the like.

In some exemplary embodiments, a client verifier may be configured to eliminate any errors, malicious usage, orders from fake profiles, or the like, while matching deliveries to clients. In some exemplary embodiments, the client verifier may comprise a code system in which a client is provided with a client code, e.g., via the application or website, which may comprise a one-time string of letters, a one-time string of numbers, or the like, which may be used to identify the client in combination with the order, to authenticate the client, or the like. In some exemplary embodiments, the client code may be provided to the client, such as via a mobile application of website. In some exemplary embodiments, the client may be required to repeat the client code to the delivery man, e.g., to verify that he is the client and not an impersonator. In some exemplary embodiments, using the code, the delivery man may know that the user is a real customer, knows how many items are ordered, or any other attribute of the order such as a type of delivery, a type of package, or the like. In some exemplary embodiments, the supplier's application or webpage may retain records of each order that can be accessed using the code. In some exemplary embodiments, using a client code may be utilized also in large apartment buildings from which more than one order may be initiated. For example, in case two people from a same building order food packages, they may both meet the delivery man in the entrance of the building, and the delivery man may provide each one with the corresponding order and verify their identity using their client code without confusing between the clients or enabling impersonations. In some exemplary embodiments, the client code may be randomly generated for each order, generated based on heuristics, or the like.

One technical effect of utilizing the disclosed subject matter may be to optimize delivery efficiency and speed. In some exemplary embodiments, by reducing a dependency on individual orders and preparing one type of dish according to a predetermined quantity, the process may be swift and efficient. In some exemplary embodiments, preparing the meals before the orders enables to provide the meals fast, and eliminates the need to wait for orders and prepare meals only after the orders are placed. In some exemplary embodiments, preparing the meals identically eliminates the need to perform customization that depend on individual orders of the day, and removes such dependency.

In some exemplary embodiments, based on accumulated crowd data, the food delivery scheme may provide an optimized route for delivery in real time, may determine or select dishes for the menu, may select dish quantities for each time in day, or the like.

Another technical effect of utilizing the disclosed subject matter is enhancing a resource utilization of the food supplier by encouraging unspecified orders that match the delivery route, the prepared quantities of food, or the like. This may reduce wasted resources, wasted food, costly personalization of meals, or the like.

Another technical effect of utilizing the disclosed subject matter is enhancing a speed of a delivery by encouraging meet-up points in convenient locations. This may ensure that the delivered goods are fresh, and that more clients can be served in less time, without waiting unnecessarily, with reduced energy consumption by the delivery vehicle, or the like.

Yet another technical effect of utilizing the disclosed subject matter is authenticating clients and matching orders to the clients via an order code. In some exemplary embodiments, authenticating an order of a client using the client's code may ensure that the client is indeed the ordering entity, provide the ordering details to the delivery man, prevent confusions between clients, or the like.

The disclosed subject matter may provide for one or more technical improvements over any pre-existing technique and any technique that has previously become routine or conventional in the art.

Additional technical problem, solution and effects may be apparent to a person of ordinary skill in the art in view of the present disclosure.

It is noted that although the disclosure is exemplified using the use case of food deliveries, the disclosed subject matter is not limited to such goods and delivery of other items may also be performed in accordance with the disclosed subject matter.

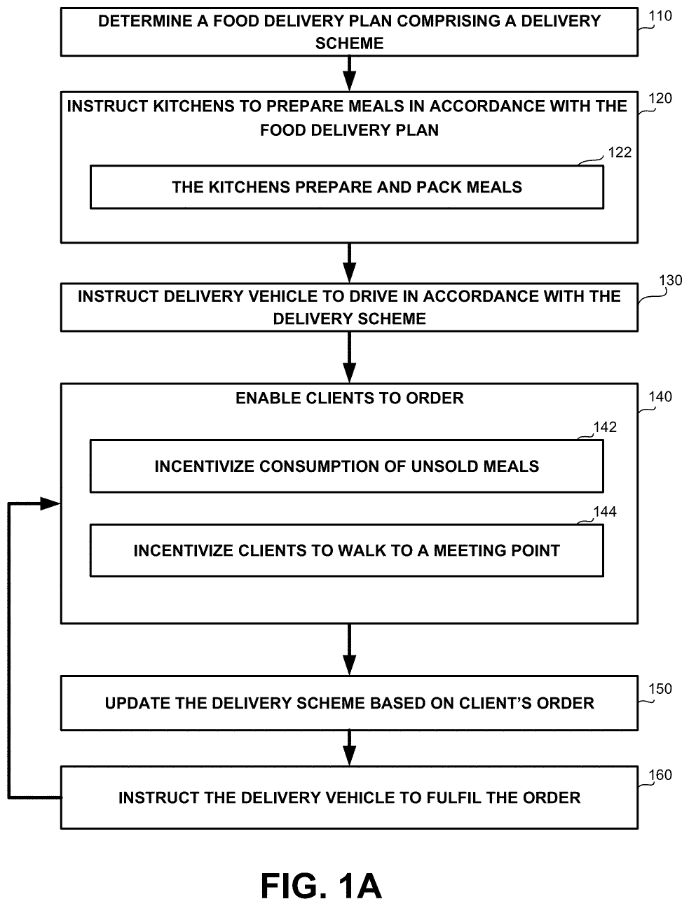

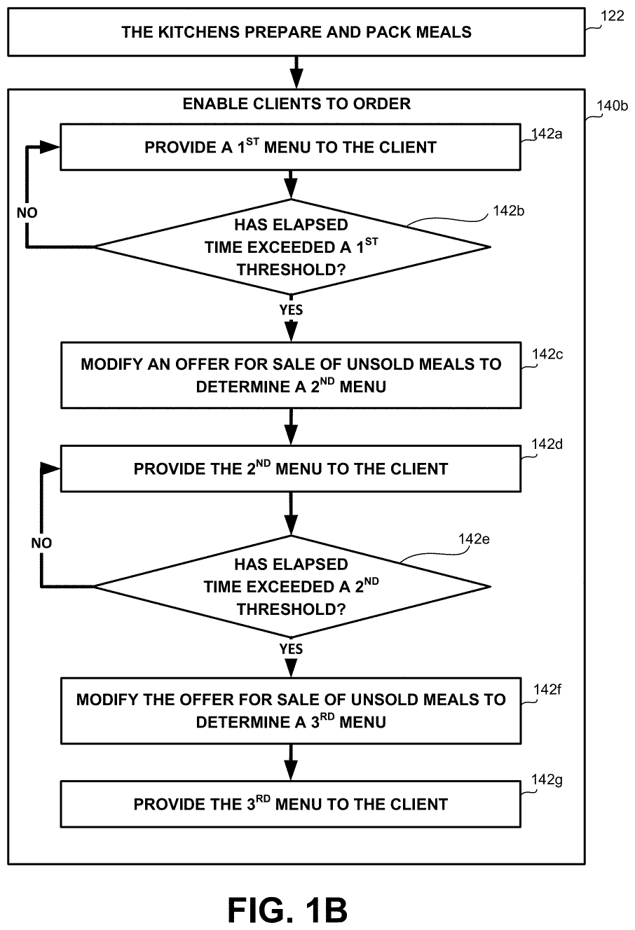

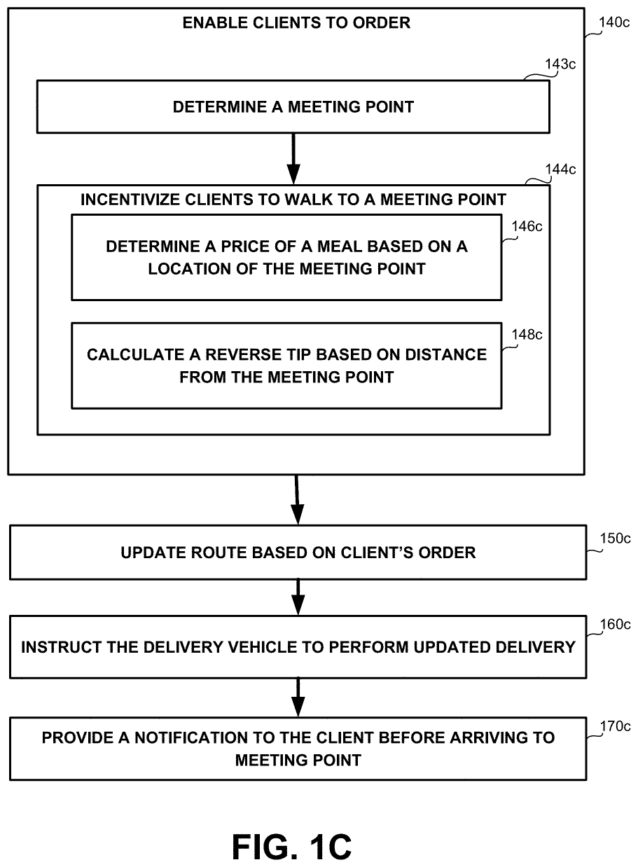

Referring now to FIG. 1A illustrating a flowchart diagram of a method, in accordance with some exemplary embodiments of the disclosed subject matter.

On Step 110, a food delivery plan may be determined for a delivery area. The food delivery plan may comprise one or more types of predefined meals to be prepared, a quantity of each type and a delivery scheme for delivering the meals in the delivery area.

In some exemplary embodiments, the food delivery plan may be determined based on a predicted demand within the delivery area. The predicted demand may be determined based on historical food delivery data in the delivery area. The predicted demand may be predicted based on a predictor, a classifier, an AI system, or the like. In some exemplary embodiments, the historical food delivery data may comprise analysis of past orders, historic usage statistics of food ordering applications, historic user reviews of users located in the delivery area, order addresses, rating popularity of dishes, a historical demand on the one or more meals, or the like. Additionally or alternatively, the food delivery plan may be determined based on global or local crowd-based behavior of a population of clients in the delivery area, such as a predicted number of clients, demographic-based eating habits, or the like. Additionally or alternatively, the food delivery plan may be determined based on quality expiration period of the one or more types of the predefined meals.

Additionally or alternatively, the food delivery plan may be determined based on current food trends, within the delivery area, globally, or the like. Food trends may be widespread changes in food preferences. Some food trends may be long-lasting, other may be determined based on daily basis, monthly basis, or the like. As an example, certain food trends may be more of a fad, some may become long-lasting, some may become a permanent fixture in the culture of food, or the like. As an example, Humous was a hit big in the late '70s, early '80s, and it trickled down to everyone else in the '90s, however, now it's not a trend. Some food trends may be local, such as in a certain delivery area, in a certain town, in a certain country, or the like, and other food trends may be global food trends indicative of current food preferences in the world. As an example, a type of meals may be trendy in one delivery area, but not in another. As another example, a type of meal may not necessarily be a trend in the delivery area, bit in accordance with global trend analysis it may be predicted to be popular in the delivery area too. The food trends may be based on demographic properties such as gender, age, geographical location, or the like. Food trends may be discussed in magazines devoted to cuisine, around the internet, in social networks, or the like.

In some exemplary embodiments, the food delivery plan may comprise which of the one or more type of predefined meals to be prepared at each predetermined timeframe, what quantity of each type to be prepared at each time frame, or the like. The food delivery plan may comprise a quantity of each type of meals may be determined for a certain timeframe, such as for a certain hour during the day, for lunch time, for dinner time, or the like. As an example, during lunch time, 900 burger meals may be required to be prepared. Additionally or alternatively, each delivery period may be divided into several intervals, each of which may be associated with a certain amount of meals. Referring to the previous example, the 900 burger meals may be required to be prepared in stages, such as during lunch time, 900 burger meals may be required to be prepared, 500 burger meals may be prepared between 12:00-13:00, 200 burger meals may be prepared between 13:00-14:00 and additional 200 burger meals may be prepared between 14:00-15:00. The one or more types of predefined meals and respective quantities may be determined based on an overall demand of each type by the population of clients in the delivery area. The number of each type may be determined based on a predicted demand for the item type in advance and before all the end-users have placed their respective orders.

Additionally or alternatively, the food delivery plan may comprise a preparation scheme for preparing the one or more types of predefined meals by one or more kitchens. The one or more kitchens may be kitchens configured for delivery, such as restaurants, food shops, or the like, that are located within or adjacent to the delivery area. Additionally or alternatively, the one or more kitchens may be kitchens may be located within a predefined radius from a central kitchen configured for packaging and distribution of prepared meals, such as about 1 kilometer, 5 minutes' drive away, or the like. The food delivery plan may comprise an amount and types of meals to be prepared by each kitchen of the one or more kitchens, based on a distance of the kitchen from the central kitchen, an estimated productivity of the kitchen, a delivery range of each kitchen, food freshness properties of the meal type prepared by the kitchen, or the like.

In some exemplary embodiments, the delivery scheme may be an initial delivery scheme based on predicted locations of the clients and predicted food type preferences of each client. In some exemplary embodiments, the delivery scheme may comprise a route for one or more vehicles carrying food in accordance with the food delivery plan. The route may be at least partially within the delivery area. In some exemplary embodiments, the route may be a predicted route, an initial route, an optimized delivery route for delivering determined quantities of the one or more types of the predefined meals in each predetermined timeframe within the delivery area, or the like. Additionally or alternatively, the route may be associated with pre-ordered meals and may be dynamically updated after any order. Additionally or alternatively, the route may correspond to locations of ordering clients within the acceptable location radius, to predicted locations of near-future orders, or the like. In some exemplary embodiments, the route may be determined or optimized by a predictor, a classifier, an AI system, or the like.

On Step 120, one or more kitchens may be instructed to prepare a plurality of meals in accordance with the food delivery plan.

The one or more kitchens may prepare the plurality of meals such that the determined quantity of each predefined meals type is available for delivery at each timeframe (Step 122). In some exemplary embodiments, the meal packages may be mounted to one or more delivery vehicles regardless of the processed deliveries.

On Step 130, the one or more delivery vehicles may be instructed to drive in accordance with the delivery scheme. In some exemplary embodiments, the delivery scheme may be an initial scheme, predicted based on historical data, based on already made orders, or the like. The one or more vehicles may be instructed to commence driving in accordance with the route before additional clients perform orders.

On Step 140, clients in the delivery area may be enabled to order meals from a list comprising the one or more types of predefined meals. In some exemplary embodiments, the list may be offered to the clients in the delivery area via communication platforms that provide access to clients, via food ordering apps, delivery platforms, restaurants websites, or the like. In some exemplary embodiments, the list from which the clients can order meals may be limited by current availability of meals carried by the one or more vehicles. When an inventory of first type of meal is depleted from the one or more vehicles storage, the first type of meal may no longer be offered for sale for the clients located within the delivery area. Additionally or alternatively, the list may be a dynamic list that comprises available types of meals at each timeslot, based on a current inventory of prepared meals, based on a location of the client, or the like.

It may be noted that the orders are made after the plurality of meals are prepared in accordance with the food delivery plan.

Additionally or alternatively, potential clients in the delivery area may be identified and provided with meal suggestions, recommendations, or the like based on matches between a current availability of meals and food preference of the client. The suggestions may be provided via a notification, an alert, an advertisement, or the like. As an example, clients may be provided with a meal suggestion in case a currently available meal matches a food preference of a user profile of the client, in case the client's address matches the delivery route, or the like. In some exemplary embodiments, the food delivery scheme may determine whether or not to suggest a meal to a client based on data-driven calculations, heuristics, predictions, or the like.

In some exemplary embodiments, the clients may be incentivized to consume unsold meals (Step 142, and FIG. 1B). Additionally or alternatively, the clients may be incentivized to walk to a meeting point (Step 144, and FIG. 1C).

On Step 150, in response to a client making an order from the list (Step 142), the delivery scheme may be automatically updated. In some exemplary embodiments, the route of the delivery vehicle that is assigned to fulfil the order in accordance with the delivery scheme may be automatically updated to include a leg that is associated with fulfilling the order. In some exemplary embodiments, the route may be updated to include the leg after the one or more vehicles commenced driving in accordance with the route. The modification of the delivery scheme of the vehicle may be performed in real-time and without requiring the one or more vehicles to reload a new meal to fulfill the order. In some exemplary embodiments, the one or more delivery vehicles may comprise more than one vehicle. The modification of the delivery scheme may be with respect with one of the vehicles, e.g. to a single route. The Route or the vehicle may be selected based on the location from which the address is performed, the delivery address or the selected meeting point, or the like. As an example, in response to obtaining a new order from an address located in a distance from an anchor location being below a predetermined proximity threshold, modifying the delivery route, in real time, to arrive to the address within a predetermined timeframe. The anchor location may be a current location of the delivery vehicle, an average location of remaining delivery vehicle, next locations on the route, a freshness level associated distance, or the like.

On Step 160, the one or more vehicles may be assigned to fulfil the order in accordance with the delivery scheme. In some exemplary embodiments, the one or more delivery vehicles may comprise a motorcycle, a bicycle, a drone, a car, a combination thereof, or the like. A vehicle of the one or more delivery vehicles may be to fulfil the order. The vehicle may be instructed to drive in accordance with the updated route throughout the client address, within a defined radius around the central kitchen, the packing spot, or the like.

In some exemplary embodiments, at delivery, the only parameter that is determined may be the number of meals that are delivered for each client. Each delivery vehicle may be on charge of delivering a single type of meals, such as hamburgers, Kebab, or the like, or a combination of a certain number of predefined meals, such as currently prepared meals of a first type and previously prepared meals of a second type, or the like.

In some exemplary embodiments, a verifier of the client indicative of the order may be utilized to verify the client prior to delivering the order.

Referring now to FIG. 1B illustrating a flowchart diagram of a method, in accordance with some exemplary embodiments of the disclosed subject matter.

On Step 142a, a first menu may be provided to the client. The first menu may comprise a first version of the list and associated prices of the one or more types of predefined meals, in accordance with the inventory thereof within the one or more vehicles.

On Step 142b, a determination whether an elapsed time from preparation of the plurality of meals (Step 122) exceeded a first freshness time threshold may be performed.

In some exemplary embodiments, each type of meals may be associated with a different freshness time threshold. As an example, a freshness time threshold of a burger meal may be about 30 minutes, 1 hour, or the like; and a freshness time threshold for heatable pasta meals may be about 3 hours, 4 hours, or the like. Additionally or alternatively, the freshness time threshold may be based on properties of storage and delivery means, whether conditions (e.g., temperature), or the like. As an example, a freshness time threshold of a rare sushi meal may be about 15 minutes, 30 minutes or the like; while a freshness time threshold of a same rare sushi meal preserved in a cooled medium may be about 2 hours, 3 hours, or the like.

On Step 142c, subsequent to the elapsed time exceeding the first freshness time threshold, an offer for sale of unsold meals from the plurality of meals may be modified, to incentivize consumption thereof. A second menu with the modified offer for sale may be determined.

In some exemplary embodiments, the modification may be on prices of the one or more types of predefined meals, such as reducing the prices, providing a discount, providing future bonuses, or the like. Additionally or alternatively, the modification may be on the list of meals offered to the client, such as removing meals from the menu that reached the first freshness time threshold, combining them with other meals as an extra, or the like.

On Step 142d, the second menu may be provided to the client.

On Step 142e, a determination whether the elapsed time from preparation of the plurality of meals (Step 122) exceeded a second freshness time threshold may be performed.

On Step 142f, subsequent to the elapsed time from preparation of the plurality of meals (Step 122) reaching the second freshness time threshold (Step 142d), the offer for sale of unsold meals from the plurality of meals may be modified again, and a third menu may be determined. In some exemplary embodiments, the modification performed on Step 142f may be different than the modification performed on Step 142c. Additionally or alternatively, the modification may be determined based on the time elapsed since the first or second freshness time thresholds. As an example, meals from a first type may be offered for sale with a first price and meals from a second type may be offered for sale with a second price. In the time between the first and the second freshness time thresholds, the price of the meal from the first type may be reduced, while the price of the of the meal from the second type may remain unchanged. In the time between the second and a third freshness time thresholds, the prices of both types may be reduced, e.g., the price of the meal from the first type may be reduced again. In the time after freshness time threshold, meals from the first type may be no longer available for order (may be destroyed, provided for charity, or the like) while meals from the second type may be offered as a bonus when ordering other meals, or the like.

On Step 142g, the third menu may be provideD to the client.

Referring now to FIG. 1C illustrating a flowchart diagram of a method, in accordance with some exemplary embodiments of the disclosed subject matter.

On Step 142c, a meeting point in which the order is to be fulfilled may be determined. The meeting point may be different than a location of the client while placing the order (e.g., an address, an exact location of the client, or the like). As an example, the meeting point may be the entrance of the building instead of the apartment door of the client, a center location adjacent to the address of the client, a distribution center, or the like.

In some exemplary embodiments, the meeting point, or multiple choices for the meeting point, may be suggested for the client, in accordance with the delivery scheme. As an example, given a plurality of orders from a single building (e.g., offices building, or the like), a meeting point at the entrance of the building may be selected for all clients from the building. As another example, a client from a high floor without an elevator, may be required to collect the order from a ground floor. As yet another example, a meeting point in a parallel or adjacent street may be selected in order to avoid entering a crowded area, extending the route, or the like.

On Step 146c, a price of a type of meal that is in stock within the one or more vehicles may be determined based on the distance from a location of the client and the meeting point. The price may be determined in a manner configured to reduce a price of the type of meal when a distance between a location of the client and the meeting point is increased. In some exemplary embodiments, the price of the meal may be in an inverse ratio with a distance from the address of the client to the meeting point.

On Step 148c, a reverse tip to be bestowed on the client may be calculated. The reverse tip may be determined based on a distance between a location of the client and the meeting point. Additionally or alternatively, the reverse tip may be based on arriving on time to the meeting point. The reverse tip may be utilized to reward and encourage the client for arriving to a distant meeting point, arrive before the predicted arrival time, or the like. In some exemplary embodiments, the reverse tip may be provided as a discount in the price of the meal or the delivery, as cash money, digital currency, as bonus points, as a credit for future orders, or the like.

On Step 170c, a notification may be provided to the client a predetermined time before the one or more vehicles arrive to the meeting point. In some exemplary embodiments, the notification may indicate a predicted arrival time of the one or more vehicles to the meeting point, to enable the client to timely reach the meeting point. In some exemplary embodiments, the predetermined time may be determined based on an estimated time required for the client to arrive to the meeting point. In some exemplary embodiments, a timing of the notification is personalized for the client. The estimated time may be determined based on historical behavior of the client, such as based on past experience with the same client, cohorts of similar clients. As a result, the amount of waiting time for both parties—the delivery vehicle and the client may be reduced.

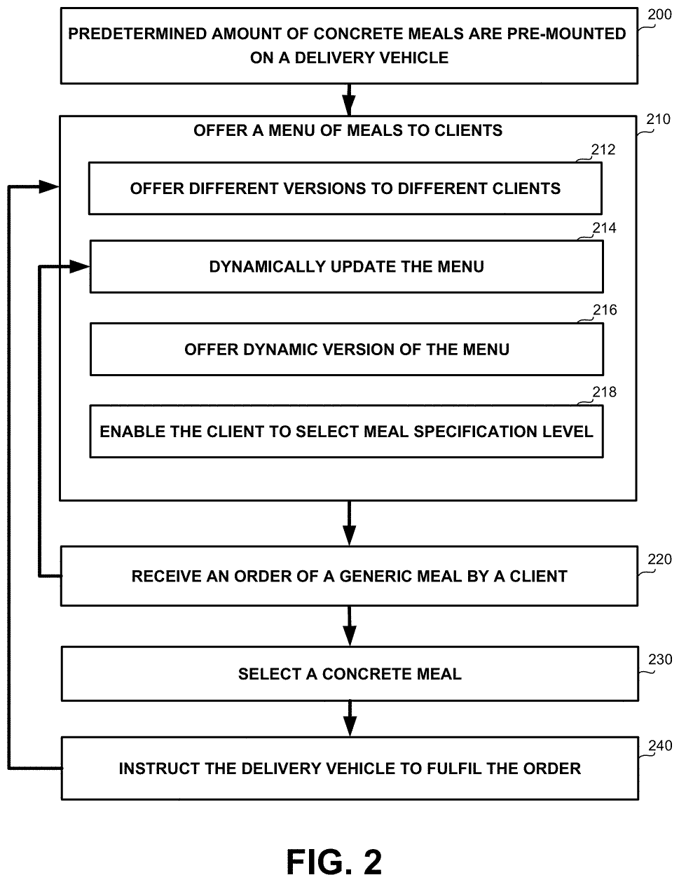

Referring now to FIG. 2 illustrating a flowchart diagram of a method, in accordance with some exemplary embodiments of the disclosed subject matter.

On Step 200, a predetermined amount of concrete meals may be pre-mounted on a delivery vehicle. Each set of alternative concrete meals may be associated with a certain generic meal, such that each concrete meal of the set of alternative concrete meals may fulfil an order of the certain generic meal.

In some exemplary embodiments, the pre-mounted concrete meals may be prepared and packed in advanced prior to a client making an order of a generic meal.

On Step 210, a menu of meals may be offered to clients. The menu may comprise a generic meal associated with a set of alternative concrete meals. Additionally or alternatively, the menu may comprise concrete meals, some of which may be from the set of alternative concrete meals associated with the generic meal.

In some exemplary embodiments, the generic meal may be associated with a meal specification level indicating a limitation on client requirements on an ordered meal. The generic meal may comprise a predefined limited amount of client requirements in accordance with the meal specification level. Each alternative concrete meal may be associated with a combination of alternatives to the predefined limited amount of user requirements.

In some exemplary embodiments, a same meal may be priced differently based on a specification constraint in the order made by the client. Each meal in the menu may be priced in accordance with a specification level. The menu may indicate a first price for the generic meal, and a second price for a concrete meal alternative to the generic meal. The first price may be lower than the second price.

In some exemplary embodiments, on Step 212, different versions of the menu may be provided to different clients. As an example, a first menu may be offered to a first client and a second menu may be offered to a second client. Both of the first and the second menus comprise the generic meal, however each menu provides a different price of the generic meal. In some exemplary embodiments, the different versions of the menu may be different in a composition thereof, such as comprising different lists of meals, in meals prices, in meals specification levels, or the like.

on Step 214, the menu may be dynamically updated. The update may be performed on a composition of the menu, a specification level of the generic meal, a price of the generic meal, or the like. In some exemplary embodiments, the menu may be updated periodically, in response to receiving an order from a client (e.g., Step 220), or the like. Additionally or alternatively, the menu may be updated based on current availability of meals (e.g., sold out meals may be removed from the menu), food freshness constraints (e.g., meals that are about to get spoiled may be removed from the menu, may be offered with lower price, or the like), an estimated time of arrival to the potential client (e.g., in accordance with freshness constraints or traffic constraints, some meals may not be offered to a certain client), or the like.

On Step 216, a dynamic version of the menu may be offered to the client in each time frame, whereby presenting different prices of the generic meal in different time frames. In some exemplary embodiments, the dynamic version may comprise a timer indicating a time in which the order must be made in order for a current displayed price to be in effect, to incentivize the client to perform the order prior to the delivery vehicle reaching a location thereof, in order to enable the delivery vehicle to fulfill the order without backtracking its route.

On Step 218, the client may be enabled to select the meal specification level of the generic meal, such as based on a price thereof, or the like. In some exemplary embodiments, the meal specification level may be selected from a group consisting of: a highest level, a medium level and a lowest level. In the highest level, the client may be enabled to select a dish type (e.g., select the concrete meal, select a category of the relevant concrete meals, select additions to the meal, or the like) and a delivery location (e.g., select the meeting point). In the medium level the delivery location may be preset (e.g., a predetermined meeting point, set in accordance with the delivery scheme, or the like) and the client may be enabled to select the dish type or other specification of the meal. In the lowest level, both of the delivery location and dish type are preset (e.g., automatically determined in accordance with a current inventory, a current location of a relevant delivery vehicle, or the like).

In some exemplary embodiments, different generic meals that are associated with the same set of alternative concrete meals may be associated with different specification levels. The client to order the second generic meal, wherein said dynamically encouraging is performed based on a current remaining inventory of concrete meals pre-mounted on the vehicle, whereby balancing over-estimated quantities of meals.

It may be noted that Steps 212, 214, 216 and 218 may be alternative steps, may be accumulated steps, a combination thereof, may be performed as a portion of Step 210, may be performed independently from Step 210, or the like. It may also be noted that Step 210 may comprise other actions or steps.

On Step 220, an order by the client of the generic meal may be received. In some exemplary embodiments, the order may be indicative of a meal specification level, may be in accordance with the meal specification level, or the like. As an example, based on a selected specification level, the client may be required to provide meal requirement, preferences, delivery location, or the like.

On Step 230, in response to said receiving the order of the generic meal, a concrete meal from the set of alternative concrete meals corresponding to the generic meal may be selected. The concrete meal may be selected based on an inventory of the delivery vehicle and based on demand by other clients.

Additionally or alternatively, the concrete meals may be selected in accordance with the meal specification level selected by the client. As an example, in case the client selected a lowest level, the concrete meal may be selected automatically in accordance with limitations or restrictions of the delivery scheme. In case the client selected a medium or a highest level, the concrete meal may be selected in accordance with the client's preferences or specifications.

On Step 240, the delivery vehicle may be instructed to fulfill the order by delivering to the client the selected concrete meal. In some exemplary embodiments, the delivery location may be automatically determined based on a current location of the delivery vehicle, and in accordance with the meal specification level selected by the client.

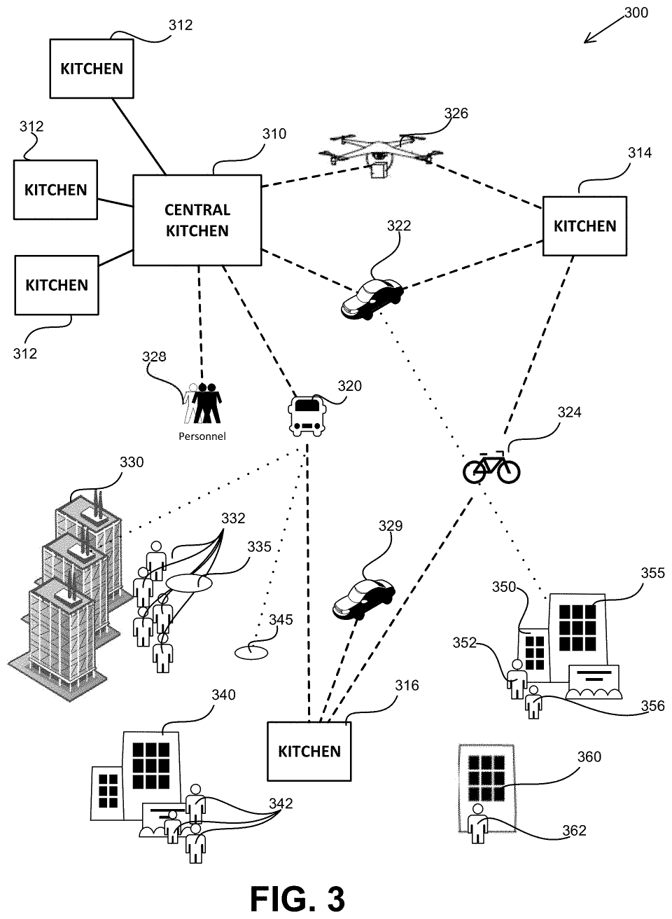

Referring now to FIG. 3 showing a schematic illustration of an exemplary environment and architecture in which the disclosed subject matter may be utilized, in accordance with some exemplary embodiments of the disclosed subject matter.

In some exemplary embodiments, a food delivery plan may be determined for Delivery Area 300. Delivery Area 300 may be a populous area, in which clients may be in close proximity to each other. The food delivery plan comprises one or more types of predefined meals to be prepared, a quantity of each type and a delivery scheme. The food delivery plan may be determined based on a predicted demand within Delivery Area 300. The food delivery scheme may be configured to limit the time and distance for arriving to clients, so to reduce a delivery cost, enable to reduce the energy consumption of the delivery vehicles, reduce the cost of the deliveries, or the like. It may be noted that Delivery Area 300 may be provided in a different geometrical shape other than a circle, such as a polygon, a square, any alternative range, or the like. In some cases, Delivery Area 300 may be determined based on estimated driving time, where the delivery vehicle scan travel within a predetermined timeframe from a central location, such as Central Kitchen 310. Additionally or alternatively, Delivery Area 300 may be defined based on an advantageous delivery radius or range of deliveries for each kitchen, based on traffic data in the area, gas costs in the area, potential meal ordering patterns in the area, or the like.

In some exemplary embodiments, the predicted demand within Delivery Area 300 may be determined based on historical food delivery data in Delivery Area 300. The historical food delivery data may comprise analysis of past orders, historic usage statistics of food ordering applications, historic user reviews of users located in Delivery Area, or the like. Additionally or alternatively, the predicted demand within Delivery Area 300 may be determine based on global food trends outside Delivery Area 300. As an example, in response to opening a new restaurant in Delivery Area 300 (such as Kitchen 316), the food type prepared by such restaurant may become a trend in the period after the opening, and may fade with time. As another example, according to global trend analysis, a certain type of food may be a trend during winter or rainy days, such as Pho noodles soup, even if it may not be a trend in Delivery Area 300, the food plan may consider it as a predicted demand based on the global analysis.

In some exemplary embodiments, the delivery may be fulfilled by one or more delivery vehicles such as Vehicles 320-329, or the like. The one or more delivery vehicles may comprise different types of vehicles, such as cars (Vehicle 322, Vehicle 329), trucks (Vehicle 320), two wheeled vehicles such as bicycles or motorcycles (Vehicle 324), drones (Vehicle 326) or the like. The one or more vehicles may be operated by one or more Delivery Members 328, such as drivers, packers, or the like. Additionally or alternatively, the delivery may be performed by walking Delivery Members 328, a combination of delivery means, or the like. The one or more vehicles may be configured for carrying, storing and delivering food. The one or more vehicles may be configured to deliver food in accordance with the food delivery plan. In some exemplary embodiments, some of the delivery vehicles may be assigned for delivery to a portion of Delivery Area, from a portion of the kitchens, or the like. As an example, Vehicle 329 may be configured to fulfil orders only from Kitchen 316, Vehicle 324 may be configured to fulfil orders directly from Kitchens 316 and 314, and not from Central Kitchen 310, or the like. In some exemplary embodiments, the delivery scheme may comprise one or more routes for the one or more vehicles, such as a route for each vehicle, a route for a combination of delivery means, or the like. Each route may be at least partially within the delivery area.

In some exemplary embodiments, one or more Kitchens 312 may be instructed to prepare a plurality of meals in accordance with the food delivery plan. Kitchens 312 may be located within a predefined radius from a Central Kitchen 310 configured for packaging and distribution of prepared meals. Kitchens 312 may be configured to prepare the meals in accordance with the food delivery plan and provide it for Central Kitchen 310 for further distribution. Additionally or alternatively, independent kitchens, such as Kitchen 314 and Kitchen 316 may be configured to prepare the meals or portions thereof in accordance with the food delivery plan. Kitchen 314 and Kitchen 316 may not be related to Central Kitchen 310, and may be configured to provide the prepared meals directly to the delivery means. In some exemplary embodiments, the food delivery plan may comprise an amount and types of meals to be prepared by each kitchen of Kitchens 312, 314 and 316. The amounts and types may be determined based on a distance of the kitchen from Central Kitchen 310, based on an estimated productivity of the kitchen, a delivery range of the kitchen, food freshness properties of the meal type prepared by the kitchen, or the like. As an example, Kitchen 316 may be a sushi restaurant instructed to prepare sushi meals with short “shelf-life”. Kitchen 316 may be selected by the food delivery plan for preparing such meals, based on Kitchen 316 being in the middle of Delivery Area 300, being close to delivery locations, or the like.

In some exemplary embodiments, meals prepared by Kitchens 310-316 in accordance with the food delivery plan may be packed and mounted on one or more Vehicles 320-329, in accordance with the delivery scheme. Thee one or more Vehicles 320-329 may be instructed to commence driving in accordance with predicted routes before any client performs the order.

In some exemplary embodiments, clients in Delivery Area 300 (such as Clients 332, Clients 342, Client 352, Client 356 and Client 362) may be enabled to order meals from a list comprising one or more types of predefined meals, after the plurality of meals are prepared by Kitchens 310-316 in accordance with the food delivery plan, and while one or more Vehicles 320-329 are driving in accordance with the predicted route. In response to a client making an order from the list, a relevant delivery vehicle may be selected to fulfil the delivery, such as based on a current inventory of meals mounted thereon, based on a current location and proximity to the location of the ordering client or the meeting point, in accordance with the delivery scheme, or the like. The route (e.g., the predicted route or portions thereof) of the relevant delivery vehicle may be updated to include a leg that is associated with fulfilling the order, whereby modifying the delivery scheme of the vehicle in real-time and without requiring the one or more vehicles to reload a new meal to fulfill the order. In some exemplary embodiments, the list from which the clients can order meals may be limited by current availability of meals carried by one or more Vehicles 320-329. As an example, when an inventory of a certain type of meal is depleted from the storage of one or more Vehicles 320-329, the certain type of meal may no longer offered for sale for the clients located within Delivery Area 300.

In some exemplary embodiments, when a client places an order, the client may be enabled to select a meeting point in which the order is to be fulfilled. As an example, Client 362 may require the ordered meals to be delivered to his Home 360 (delivery to door). Additionally or alternatively, the meeting point may be different than the current location or address of the client. As an example, Clients 352 and 356 may be required to meet the delivery vehicle in front of their Houses (350 and 355) and not inside the building. As another example, the closest meeting point to Building 340 may be Meeting Point 350, and Clients 342 may be enabled to select Meeting Point 345 (or other available distinct meeting point) for picking their orders. As yet another example, Clients 332 from Buildings 330 may be required to arrive at Meeting Point 335 in front of Buildings 330, in order to make the delivery process more efficient. In some exemplary embodiments, a notification may be provided to the clients a predetermined time before the one or more vehicles arrive to the meeting point. The notification may be configured to indicate a predicted arrival time of the relevant delivery vehicle to the meeting point, in order to enable the client to timely reach the meeting point. It may be noted that the timing of the notification may be personalized and may be determined for each client individually. Specifically, the predetermined time may be determined based on an estimated time required for the client to arrive to the meeting point, based on historical behavior of the client, or the like. As an example, Client 352 may be notified before Client 356 to arrive almost to the same meeting point, in similar time, as based on previous behavior of the clients, it takes more time for Client 352 to arrive than Client 354, Client 352 lives in a higher floor, or the like. Additionally or alternatively, the timing of the notification may be determined based on traffic situation, real time locations of one or more delivery vehicle, the delivery scheme, or the like.

In some exemplary embodiments, prices of the meals offered for the clients may be set based on the selected meeting point, in a manner configured to reduce a price of the meal when a distance between a location of the client and the meeting point is increased. As an example, the same meal may be priced for Client 362 higher than for Clients 342, as Meeting Pont 345 is more distinct from Building 340 than the meeting point of Client 362 which is Home 360 itself. Additionally or alternatively, a reverse tip may be provided bestowed to the clients based on a distance between a location of the client and the meeting point, in order to rewarding the client for arriving to a distant meeting point.

In some exemplary embodiments, the delivery scheme may be configured to determine delivery routes for one or more Vehicles 320-329 that comply with a maximum delivery time threshold. In some exemplary embodiments, the maximum delivery time threshold may indicate a time limit from food preparation to completing the delivery, from food packaging to completing the delivery, or the like. As example, in case the meals include hamburger meals, a delivery time threshold may be determined, e.g., 45 minutes, from preparation to delivery, indicating that for each delivery round, the last delivered hamburger meal is required to be provided no more than 45 minutes after preparation. In some exemplary embodiments, subsequent to an elapsed time from preparation of the plurality of meals by one or more Kitchens 310-316 reaching a freshness time threshold in accordance with the meal type, an offer for sale of unsold meals from the plurality of meals may be modified to incentivize consumption of the unsold meals that are about to get void or spoiled. Additionally or alternatively, other modifications may be performed, such as returning the unsold meals to Central Kitchen 310, or the like. As an example, meals left unsold after a period of the maximum delivery time threshold, may be disposed, sold at a discount, provided as a donation, a charity, or the like. In some exemplary embodiments, different delivery time thresholds or freshness time thresholds may be determined for different types of dishes, for different clients, or the like. In some exemplary embodiments, different freshness time threshold may be determined for different phases of the food. As an example, a freshness threshold may indicate that the food is fresh until the threshold but is still edible thereafter, while a mildew threshold may indicate that the food is not to be consumed, that the food does not comply with food regulations, or the like.

In some exemplary embodiments, a menu of meals that comprises generic meals may be offered to clients in Delivery Area 300. Each generic meal may be associated with a set of alternative concrete meals, each of which fulfils an order of the generic meal. Predetermined amounts of concrete meals may be pre-mounted on one or more Delivery Vehicle 320-329. The pre-mounted concrete meals may be prepared and packed in advanced prior to a client making an order of a generic meal. In response to receiving an order of a generic meal, a concrete meal from the set of alternative concrete meals of the generic meal may be selected based on an inventory of the closest delivery vehicle to the client and based on demand by other clients. The delivery vehicle may be instructed to fulfill the order by delivering to the client the selected concrete meal.

In some exemplary embodiments, different menus may be offered to different clients, based on the client's location, a selected delivery method, client's demographic properties, client's history of orders, or the like. The different menus may differ in meals prices, and meals specification level, or the like. As an example, the inventory of Vehicle 320 may be different than the inventory of Vehicle 322 at a certain timepoint. The menu offered for clients over the delivery route of Vehicle 320 may be indicative of the inventory thereof and may be different than the menu offered for clients over the delivery route of Vehicle 322. Additionally or alternatively, the prices of the meals may be dynamically and independently updated for each delivery route based on a current availability of meals mounted on the vehicle, food freshness constraints, an estimated time of arrival to the potential client, or the like. Additionally or alternatively, a dynamic version of the menu may be displayed to clients in each time frame, presenting different prices of a generic meal in different time frames. The dynamic version may comprise a timer indicating a time in which the order must be made in order for a current displayed price to be in effect, whereby incentivizing the client to perform the order prior to the delivery vehicle reaching a location of the client, and enabling the delivery vehicle to fulfill the order without backtracking its route. As an example, when Vehicle 320 is on its way to Meeting Point 335, Clients 332 and other potential clients in Buildings 330, may be offered to order generic meals in accordance with the inventory of Vehicle 320. The price may be reduced in accordance with the proximity of Vehicle 320 to Meeting Point 335. The closest Vehicle 320 is to Meeting point 335, and the lowest the variety of meals therein, the price and the meal specification level enabled for the client may be lower. As an example, clients from Buildings 330 may not be enabled to select a meeting point, as the offered meeting point may be Meeting Point 335 which Vehicle 320 is about to arrive. As another example, clients from Buildings 330 may not be enabled to select a meal type of other parameters of the meal, and instead will be offered to order a generic meal, such as a pizza without selecting a topping, a hamburger meal without selecting being with or without cheese, or the like.

Additionally or alternatively, the clients may be dynamically encouraged to order generic meals associated with a lower specification level, and even without a possibility to select or specify any requirement, by offering generic meals in lower prices based on a current remaining inventory of concrete meals pre-mounted on the vehicle, whereby balancing over-estimated quantities of meals.

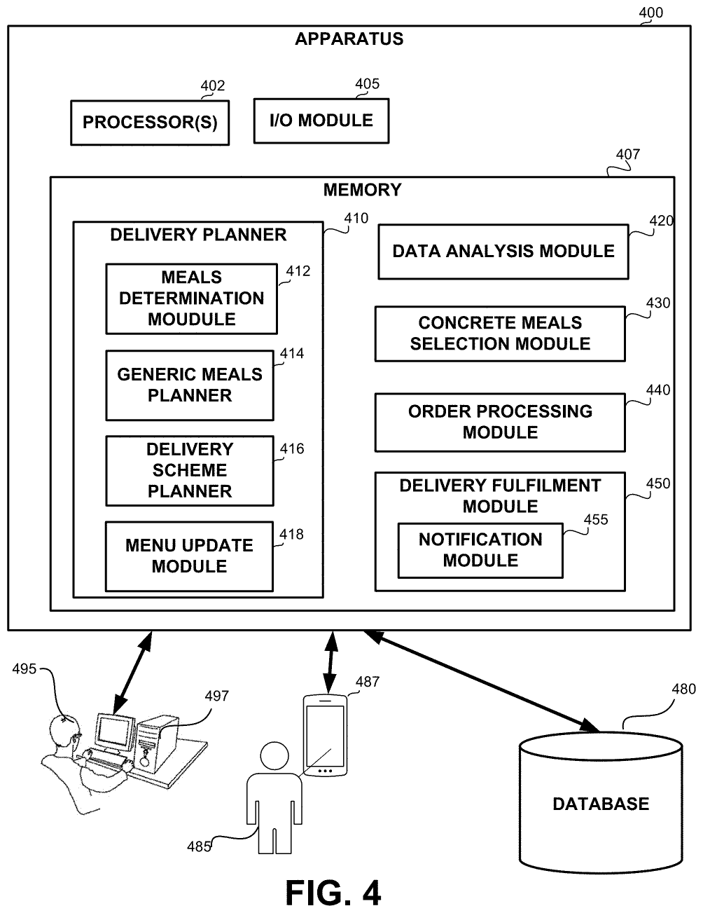

Referring now to FIG. 4 showing a block diagram of an apparatus, in accordance with some exemplary embodiments of the disclosed subject matter. An Apparatus 400 may be configured to support parallel user interaction with a real-world physical system and a digital representation thereof, in accordance with the disclosed subject matter. In some exemplary embodiments, Apparatus 400 may be configured to manage delivery of food or other goods in one or more delivery areas.

In some exemplary embodiments, Apparatus 400 may comprise one or more Processor(s) 402. Processor 402 may be a Central Processing Unit (CPU), a microprocessor, an electronic circuit, an Integrated Circuit (IC) or the like. Processor 402 may be utilized to perform computations required by Apparatus 400 or any of it's subcomponents.

In some exemplary embodiments of the disclosed subject matter, Apparatus 400 may comprise an Input/Output (I/O) module 405. I/O Module 405 may be utilized to provide an output to and receive input from a user, such as, for example receiving orders from clients such as User 485, directly from restaurants or administrators such as User 495, providing notifications to clients such as User 485, sending instructions to delivery staff or kitchens such as to User 495, or the like.

In some exemplary embodiments, Apparatus 400 may comprise Memory 407. Memory 407 may be a hard disk drive, a Flash disk, a Random Access Memory (RAM), a memory chip, or the like. In some exemplary embodiments, Memory 407 may retain program code operative to cause Processor 402 to perform acts associated with any of the subcomponents of Apparatus 400.

In some exemplary embodiments, Delivery Planner 410 may be configured to determine a food delivery plan for a delivery area. The food delivery plan may comprise one or more types of predefined meals and a quantity of each type to be prepared at each timeframe. Delivery Planner 410 may be configured to utilize Meal Determination Module 412 to determine the food delivery plan based on a predicted demand on each meal within the delivery area. Additionally or alternatively, Meals Determination Module 412 may be configured to select meals that provide a best outcome, benefit, or the like, such as based on prices of the meals, freshness constraints, or the like. Meals Determination Module 412 may be configured to determine which meals to be prepared in each time frame, a quantity of each type, a composition of the meal, or the like. Additionally or alternatively, Meals Determination Module 412 may be configured to determine the meals to be prepared by each participating kitchen. Additionally or alternatively, Meals Determination Module 412 may be configured to determine the meals and quantities thereof based on trends in the delivery area, global trends, a combination thereof, or the like.

In some exemplary embodiments, Meals Determination Module 412 may be configured to select from a list of possible meals one or more meals to be offered on a menu, based on a prediction of dish demand. In some exemplary embodiments, the dish selection may be performed on a daily basis, a weekly basis, an hourly basis, a combination thereof, or the like. As an example, every week new data may be gathered and used to define a weekly schedule including different dishes for each hour of the day.

In some exemplary embodiments, Meals Determination Module 412 may be configured to utilize Data Analysis Module 420 in order to predict demand of each type of meals. Data Analysis Module 420 may be configured to determine the demand based on historical food delivery data in the delivery area, such as analysis of past orders, historic usage statistics of food ordering applications, historic user reviews of users located in the delivery area, or the like. In some exemplary embodiments, Data Analysis Module 420 may be configured to analyze various criteria, heuristics, clients' past likings (e.g., based on client feedback), or the like.

In some exemplary embodiments, Delivery Planner 410 may be configured to project a number of meals that are to be prepared of each type per delivery time in the day, number of items per dish or meal, or the like. Delivery Planner 410 may be configured to utilizing an AI system or any other calculation to predict the demand for a certain item. As an example, Delivery Planner 410 may be configured to determine that 100 meals of pancakes are to be prepared for a delivery area during a delivery time window of 12:15-1:00 PM, while 200 meals of pancakes are to be prepared for the same area during a delivery time window of 1:10-2:00 PM.

In some exemplary embodiments, Delivery Planner 410 may be configured to utilize Data Analysis Module 420 for determining the deliver plan. Data Analysis Module 420 may be configured to apply one or more AI systems, route optimization algorithms, resource allocation algorithms, predictors, classifiers, Artificial Neural Networks (ANNs), a combination thereof, or the like, on data related to food delivery in the food delivery area. Data Analysis Module 420 may be configured to collect data from apps, obtain and provide data to Database 480, accumulate data parameters and values for Database 480. or the like.

In some exemplary embodiments, Database 480 may comprise historic data, delivery related information such as previous orders, application or website usage statistics, location information such as order addresses, proximity of ordering addresses to the kitchen's location, proximity of different ordering addresses in the area, dish variety, constrains of the remaining dishes such as aging constraints, or the like. Additionally or alternatively, Database 480 may comprise information associated to types of dishes, such as a rating popularity of a dish on an ordering application of platform, global or local data trends of dish preferences that may be available publicly such as based on a number of google searches for a dish in a certain radius, city, country, or the like, a cost of a preparing the dish, different pricings that were used when selling the dish in the past, dish preparation timing constraints, dish quality expiration period (time from preparation of the dish until the dish is not acceptable for a quality delivery), dish ingredient constraints such as seasonal ingredients, dish popularity in context to season or time of year (e.g., soups in winter, salads in summer), an amount of time during which an ordered dish was on the menu, a similarity of dishes, comparative pricing of the dish (the pricing of a dish compared to pricings of other venues offering a same or similar dish), or the like.

Additionally or alternatively, the food delivery plan may comprise a delivery scheme, that comprises a route for one or more vehicles carrying food in accordance with the food delivery plan. In some exemplary embodiments, Delivery Planner 410 may be configured to utilize a Delivery Scheme Planner 416 to determine the delivery scheme. Delivery Scheme Planner 416 may be configured to determine a delivery route for each delivery vehicle, and which meals to be delivered by the delivery vehicle. Each route may be located, at least partially, within the delivery area. Delivery Scheme Planner 416 may be configured to optimize the delivery route to provide the quickest or shortest route while ensuring the delivered meals are still fresh, e.g., have a delivery time that is below a freshness threshold. In some exemplary embodiments, Delivery Scheme Planner 416 may be configured to determine a delivery scheme may that projects an optimized route for each delivery, an optimized amount of delivered packages for each delivery, or the like. In some exemplary embodiments, Delivery Scheme Planner 416 may be configured to modify the delivery scheme or a relevant route in real time, such as based on new orders that are processed by Order Processing Module 440, based on a proximity of ordering addresses to the delivery man's current location, proximity of an ordering address to the remaining ordering addresses in the area, a freshness level of the food, or the like.

In some exemplary embodiments, Delivery Planner 410 may be configured to instruct one or more kitchens to prepare a plurality of meals in accordance with the food delivery plan, such as via I/O Module 405, by Device 497 and User 495, or the like. Delivery Planner 410 may be configured to receive a verification that the determined quantity of each predefined meals type is available for delivery at each time frame.

In some exemplary embodiments, clients in the delivery area (such as User 485) may be enabled to order meals from a list comprising the one or more types of predefined meals after the plurality of meals are prepared in accordance with the food delivery plan. The clients may be enabled to order via mobile apps, using Mobile Device 487, or the like. Additionally or alternatively, the clients may place orders directly at a restaurant medium, and the orders may be provided to Apparatus 400 by User 495.

Menu Update Module 418 may be configured to dynamically modify the menu being presented to clients for offering meals for order. In some exemplary embodiments, upon Meals Determination Module 412 selecting the meals to be presented in the menu, Menu Update Module 418 may be configured to provide a digital menu to be accessible to clients via a corresponding mobile application, website, or any other communication medium (such as via Mobile Device 487). In some exemplary embodiments, Menu Update Module 418 may be configured to modify the presented menu based on a tome of the day, during current demand, or the like. As an example, during a first day, Meals Determination Module 412 may predict that only hamburgers are to be included in the menu, while during a second day, Meals Determination Module 412 may determine that cheesecakes are to be offered in the morning and pasta is to be offered in the evening.

In some exemplary embodiments, Menu Update Module 418 may be configured to modify an offer for sale of unsold meals when a freshness time threshold from preparing such meals elapses. The modification may be performed to incentivize consumption of the unsold meals that are about to get damaged. Each meals type may be associated with a certain freshness time threshold in accordance with the components of the meal, freshness constraints, or the like. The freshness time threshold may be obtained by I/O Module 405, may be automatically determined, such as using Data Analysis Module 420, may be dynamically determined based on input from the delivery staff, or the like. In some exemplary embodiments, Menu Update Module 418 may be configured to modify the price of the meals in accordance with the elapsed time from preparation of the plurality of meals, such as reducing the price after each predetermined timeframe, such as every 10 minutes, every 30 minutes, or the like.

Additionally or alternatively, Menu Update Module 418 may be configured to update the menu from which the clients can order meals based on current availability of meals carried by the delivery vehicles at each time point. When an inventory of first type of meal is depleted from the delivery vehicles' storage, Menu Update Module 418 may be configured to delete the first type of meal from the menu.

In some exemplary embodiments, Menu Update Module 418 may be configured to determine prices of the meal in the menu based on availability of meals, a distance between a location of the client and the meeting point, or the like.

In some exemplary embodiments, Order Processing Module 440 may be configured to analyze orders made by the clients, and instruct Delivery Fulfilment Module 450 to update the route of the relevant delivery vehicle to include a leg that is associated with fulfilling the order. Delivery Fulfilment Module 450 may be configured to instructing the relevant delivery vehicle to drive in accordance with the route, whereby enabling fulfillment of the order. Fulfilment Module 450 may be configured to instruct the relevant delivery vehicle directly via I/O module, via Device 497, or the like. It may be noted that the delivery vehicles may be instructed to commence driving in accordance with the route before a client performs an order, such as while delivering other meals, entering the delivery area and waiting for instructions, or the like. In response to the order, Delivery Scheme Planner 416 may be configured to modify the delivery scheme of the vehicle in real-time without requiring the delivery vehicle to reload a new meal to fulfill the order, and while minimizing the change in the route.

In some exemplary embodiments, Order Processing Module 440 may be configured to determine a meeting point for delivery in accordance with a meals specification level selected by the client. Order Processing Module 440 may be configured to utilize Delivery Scheme Planner 416 for determining the meeting point, based on other pre-set meeting points, based on traffic consideration, delivery of other meals, or the like. In some exemplary embodiments, Order Processing Module 440 may be configured to calculate a reverse tip to be bestowed on the client, based on a distance between a location of the client and the meeting point, whereby rewarding the client for arriving to a distant meeting point.

In some exemplary embodiments, Order Processing Module 440 may be configured to provide the meeting point in which the order is to be fulfilled to Delivery Fulfilment Module 450. Notification Module 455 may be configured to providing a notification to the client a predetermined time before the delivery vehicle arrives to the meeting point. The notification may indicate a predicted arrival time of the delivery vehicle to the meeting point, to enable the client to timely reach the meeting point. Notification Module 455 may be configured to determine the notification timing based on an estimated time required for the client to arrive to the meeting point. The estimated time may be personalized for the client and may be determined based on historical behavior of the client.

In some exemplary embodiments, Delivery Planner 410 may be configured to utilize Generic Meals Planner 414 for determining generic meals and associated sets of alternative concrete meals thereof, a quantity of each concrete meal to be prepared, which kitchen is instructed to prepare each concrete meal, or the like. Generic Meals Planner 414 may be configured to define each generic meal in a manner that each concrete meal of the set of alternative concrete meals thereof fulfils an order of the generic meal. Generic Meals Planner 414 may be configured to determine the amount of concrete meals of the set of alternative concrete meals to be pre-mounted on each delivery vehicle in the deliver area. Generic Meals Planner 414 may be configured to instruct the relevant kitchens, the package center, the central kitchen, the delivery fleet, or the like, to prepare and pack the concrete meals and to mount the relevant amount of such meals to the relevant delivery vehicle.

In some exemplary embodiments, Menu Update Module 418 may be configured to update the menu offered to clients in the delivery area to comprise the generic meals determined by Generic Meals Planner 414, in accordance with a current availability of each meal. In some exemplary embodiments, Menu Update Module 418 may be configured to update a price of each generic meal in accordance with a specification constraint in the order made by the client, such as a price of a generic meal to be lower than a price of alternative concrete meals thereof. Menu Update Module 418 may be configured to dynamically modify meals composition, meals prices, specification levels of each generic meal, list of meals, or the like. Menu Update Module 418 may be configured to update the menu based on a current availability of meals, food freshness constraints, an estimated time of arrival to the potential client, or the like. Additionally or alternatively, Menu Update Module 418 may be configured to update the menu dynamically, based on properties of the client the menu being presented thereto. The properties may be a client's current location or address, a selected meeting point, a selected delivery method, client's demographic properties, client's history of orders, or the like.

In some exemplary embodiments, Menu Update Module 418 may be configured to generate a dynamic version of the menu to be presented to the client in each time frame. The dynamic version may be configured to enable presenting different prices of the generic meals in different time frames. The dynamic version may comprise a timer indicating a time in which the order must be made in order for a current displayed price to be in effect.

Additionally or alternatively, Generic Meals Planner 414 may be configured to associate each generic meal with one or more meal specification levels indicating a limitation on client requirements on an ordered meal. Each generic meal may comprise a predefined limited amount of client requirements in accordance with the meal specification level, such that each alternative concrete meal is associated with a combination of alternatives to the predefined limited amount of user requirements. Generic Meals Planner 414 may be configured to define different levels of specification for each generic meal, and price each version accordingly. Additionally or alternatively, Menu Update Module 418 may be configured to update the menu to reflect a possibility for the client to select the meal specification level, such as from a group consisting of: a highest level, a medium level and a lowest level. Menu Update Module 418 may be configured to present the options to the clients of selecting each specification level, such as which specifications the client can select, which constraints on the meal or on the meeting point the client can provide, the price of each selection, or the like. In some exemplary embodiments, Order Processing Level 440 may be configured to analyze the orders in accordance with the meal specification level selected by the client, and accordingly process a meeting point, a delivery location, or the like. Additionally or alternatively, Order Processing Level 440 may be configured to instruct Concrete Meals Selection Module 430 to select a relevant concrete meal in accordance with the specification level selected by the client.

In some exemplary embodiments, in response to receiving an order by s client of a generic meal, Order Processing Module 440 may be configured to analyze the order and instruct Concrete Meals Selection Module 430 to select a relevant concrete meal to be delivered to the client. Concrete Meals Selection Module 430 may be configured to select a concrete meal from the set of alternative concrete meals associated with the generic meal based on an inventory of the relevant delivery vehicle and based on demand by other clients. The relevant delivery vehicle may be selected by Delivery Scheme Planner 416, based on input to Delivery Fulfilment Module 450, or the like. Delivery Fulfilment Module 450 may be configured to instruct the relevant delivery vehicle to fulfill the order by delivering to the client the selected concrete meal.

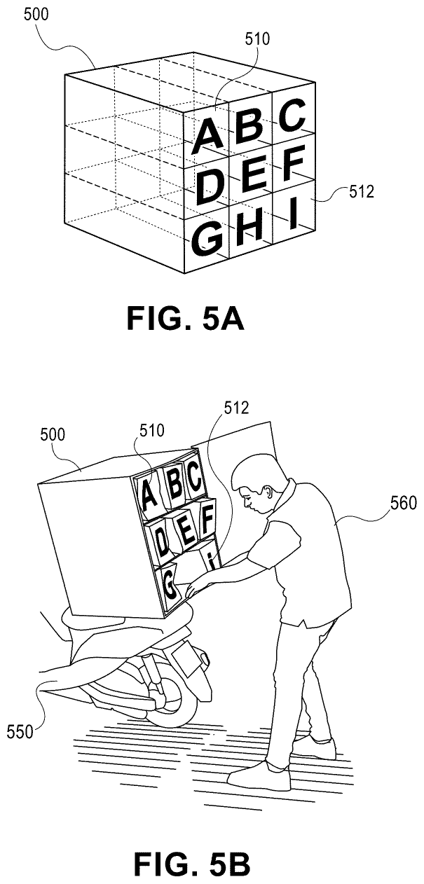

Referring now to FIGS. 5A and 5B, sowing a schematic illustration of an exemplary delivery container in accordance with some exemplary embodiments of the disclosed subject matter.

In some exemplary embodiments, a Delivery Container 500 may be utilized to store prepared meals on the delivery vehicles, such as Vehicle 550. Delivery Container 500 may comprise multiple cells or compartments (as an example, 510 and 512) for storing different meals from different types. As an example, Compartment 510 (marked A) may be utilized to store a first type of meals (such as hamburger, hot dogs, or the like), and Compartment 512 (marked I) may be utilized to store a second type of meals (such as sushi, pasta, or the like). The order of the compartments may be designed based on the order of the meals being stored therein, properties of the meals (e.g., required storage temperature, humidity, weight constraints, or the like). Additionally or alternatively, the order of the compartment may be designed based on the order of delivering the prepared meals, in accordance with the delivery scheme, or the like.

In some exemplary embodiments, Delivery Staff 560 may collect the prepared meals from different kitchens and mount them in the Delivery Container 500. Additionally or alternatively, Delivery Container 500 may be arranged and filled with prepared meals before being mounted on the delivery vehicle, such as in a central kitchen, a packing center, or the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
determining a food delivery plan for a delivery area, wherein the food delivery plan comprises one or more types of predefined meals to be prepared, a quantity of each type and a delivery scheme, wherein the delivery scheme comprises a route for one or more vehicles carrying food in accordance with the food delivery plan, wherein the route is at least partially within the delivery area, wherein said determining the food delivery plan is performed based on a predicted demand within the delivery area;
instructing one or more kitchens to prepare a plurality of meals in accordance with the food delivery plan, whereby the determined quantity of each predefined meals type is available for delivery;
enabling clients in the delivery area to order meals from a list comprising the one or more types of predefined meals, wherein orders are made after the plurality of meals are prepared in accordance with the food delivery plan;
in response to a client making an order from the list, automatically updating the route to include a leg that is associated with fulfilling the order; and
instructing the one or more vehicles to drive in accordance with the route, whereby enabling fulfillment of the order.

2. The method of claim 1,
wherein the one or more vehicles is instructed to commence driving in accordance with the route before the client performs the order,
wherein after the one or more vehicles commenced driving in accordance with the route, the route is updated to include the leg, whereby modifying the delivery scheme of the vehicle in real-time and without requiring the one or more vehicles to reload a new meal to fulfill the order.

3. The method of claim 1 further comprises:
subsequent to an elapsed time from preparation of the plurality of meals of a single type of meal reaching a freshness time threshold relating to the single type of meal, modifying an offer for sale of unsold meals from the plurality of meals of the single type of meal, whereby incentivizing consumption of the unsold meals of the single type.

4. The method of claim 3 further comprises: subsequent to the elapsed time from preparation of the plurality of meals of the single type of meal reaching a second freshness time threshold, performing a second modification of the offer for sale of the unsold meals of the single type.

5. The method of claim 1, wherein the predicted demand is determined based on historical food delivery data in the delivery area, wherein the historical food delivery data comprises at least one of: analysis of past orders, historic usage statistics of food ordering applications, and historic user reviews of users located in the delivery area.

6. The method of claim 1, wherein the list from which the clients can order meals is limited by current availability of meals carried by the one or more vehicles, whereby when an inventory of first type of meal is depleted from the one or more vehicles' storage, the first type of meal is no longer offered for sale for the clients located within the delivery area.

7. The method of claim 1, wherein the order of the client indicates a meeting point in which the order is to be fulfilled, wherein the client is not located at the meeting point when making the order, wherein the method further comprises:
providing a notification to the client a predetermined time before the one or more vehicles arrive to the meeting point, wherein the notification indicates a predicted arrival time of the one or more vehicles to the meeting point, whereby the client is enabled to timely reach the meeting point.

8. The method of claim 7, wherein the predetermined time is determined based on an estimated time required for the client to arrive to the meeting point, wherein the estimated time is determined based on historical behavior of the client, whereby a timing of the notification is personalized for the client.

9. The method of claim 7, wherein said enabling clients to order meals comprises: determining a price of a type of meal that is in stock within the one or more vehicles, wherein said determining is performed in a manner configured to reduce a price of the type of meal when a distance between a location of the client and the meeting point is increased.

10. The method of claim 7, further comprises: calculating a reverse tip to be bestowed on the client, wherein the reverse tip is determined based on a distance between a location of the client and the meeting point, whereby rewarding the client for arriving to a distant meeting point.

11. A method comprising:
offering to a client a menu of meals, wherein the menu comprises a generic meal, wherein the generic meal is associated with a set of alternative concrete meals, wherein each concrete meal of the set of alternative concrete meals fulfils an order of the generic meal, wherein a predetermined amount of concrete meals of the set of alternative concrete meals is pre-mounted on a delivery vehicle, wherein the pre-mounted concrete meals are prepared and packed in advanced prior to a client making an order of the generic meal;
receiving an order by the client of the generic meal;
in response to said receiving the order of the generic meal, selecting a concrete meal from the set of alternative concrete meals, wherein said selecting is based on an inventory of the delivery vehicle; and
instructing the delivery vehicle to fulfill the order by delivering to the client the selected concrete meal.

12. The method of claim 11, wherein said selecting is further based on predicted demand by other clients for the set of alternative concrete meals.

13. The method of claim 11, wherein the menu indicates a first price for the generic meal, wherein the menu further comprises the concrete meal and indicates a second price for the concrete meal, wherein the first price is lower than the second price, whereby a same meal is priced differently based on a specification constraint in the order made by the client.

14. The method of claim 11 further comprises:
offering a second menu of meals to a second client, wherein the second menu comprises a second generic meal, wherein the second generic meal is associated with a subset of the set of alternative concrete meals, wherein each concrete meal of the subset of the set of alternative concrete meals fulfils an order of the second generic meal, wherein orders made by the second client are fulfilled using inventory of the delivery vehicle,
wherein the second client is different than the client in at least one of: a client's location, a selected delivery method, client's demographic properties, and client's history of orders, and
wherein the second menu is different than the menu in a specification level of one or more meals offered.

15. The method of claim 11 further comprises:
dynamically updating the menu, wherein said updating comprises updating at least one of: a composition of the menu, a specification level of the generic meal, and a price of the generic meal;
wherein said dynamically updating is performed based on at least one of: a current availability of meals in the inventory of the delivery vehicle, food freshness constraints, and an estimated time of arrival to the client.

16. The method of claim 11, wherein said offering comprises displaying a dynamic version of the menu to the client in each time frame of a set of timeframes, wherein the set of timeframes comprise two timeframes that are comprised by a time window during which the delivery vehicle retains the inventory and does not replenish the inventory.

17. The method of claim 16, wherein the dynamic version comprises a timer indicating a time in which the order must be made in order for a current displayed price to be in effect, whereby incentivizing the client to perform the order prior to the delivery vehicle reaching a location of the client, whereby incentivizing optimal route for the delivery vehicle.

18. The method of claim 11, wherein each meal in the menu of meals is associated with a meal specification level indicating a limitation on client requirements on an ordered meal, wherein the meal comprises a predefined limited amount of client requirements in accordance with the meal specification level, wherein each alternative concrete meal is associated with a combination of alternatives to the client requirements in accordance with the limitation of the meal specification level.

19. The method of claim 18, wherein the meal specification level is selected from a group consisting of: a high specification level, a first medium specific level, a second medium level, and a low specification level; wherein in the high specification level the client is enabled to select a dish type and a delivery location; wherein in the first medium specification level the client is enabled to select the dish type but not the delivery location; wherein in the second medium specification level the client is enabled to select the delivery location but not the dish type; wherein in the low specification level the client is unable to select the delivery location and the dish type.

20. The method of claim 19, wherein in response to the meal specification level of an order meal being the first medium specification level or the low specification level, automatically determining the delivery location based on a current location of the delivery vehicle, and providing a notification to the client of the determined delivery location.

21. A food delivery system adapted to perform the steps of:
offering to a client a menu of meals, wherein the menu comprises a generic meal, wherein the generic meal is associated with a set of alternative concrete meals, wherein each concrete meal of the set of alternative concrete meals fulfils an order of the generic meal, wherein a predetermined amount of concrete meals of the set of alternative concrete meals is pre-mounted on a delivery vehicle, wherein the pre-mounted concrete meals are prepared and packed in advanced prior to a client making an order of the generic meal;
receiving an order by the client of the generic meal;
in response to said receiving the order of the generic meal, selecting a concrete meal from the set of alternative concrete meals, wherein said selecting is based on an inventory of the delivery vehicle; and
instructing the delivery vehicle to fulfill the order by delivering to the client the selected concrete meal.

22. A computer program product comprising a non-transitory computer readable storage medium retaining program instructions, which program instructions when read by a processor, cause the processor to perform a method comprising:
determining a food delivery plan for a delivery area, wherein the food delivery plan comprises one or more types of predefined meals to be prepared, a quantity of each type and a delivery scheme, wherein the delivery scheme comprises a route for one or more vehicles carrying food in accordance with the food delivery plan, wherein the route is at least partially within the delivery area, wherein said determining the food delivery plan is performed based on a predicted demand within the delivery area;
instructing one or more kitchens to prepare a plurality of meals in accordance with the food delivery plan, whereby the determined quantity of each predefined meals type is available for delivery;
enabling clients in the delivery area to order meals from a list comprising the one or more types of predefined meals, wherein orders are made after the plurality of meals are prepared in accordance with the food delivery plan;
in response to a client making an order from the list, automatically updating the route to include a leg that is associated with fulfilling the order; and
instructing the one or more vehicles to drive in accordance with the route, whereby enabling fulfillment of the order.
